(19) United States
(12) Patent Application Publication
(10) Pub. No.: US 2003/0010230 A1
(43) Pub. Date: Jan. 16, 2003

(54) Printing unit

(76) Inventor: Johannes Georg Schaede, Wurzburg (DE)

Correspondence Address: Douglas R Hanscom, Johns Tullar & Cooper, PO Box 2266 Eads Station, Arlington, VA, 22202, US

(21) Appl. No.: 10/181,427

(22) PCT Filed: Dec. 16, 2000
(86) PCT No.: PCT/DE00/04501

(30) Foreign Application Priority Data
Jan. 25, 2000 (DE) 100 03 027.0
May 25, 2000 (DE) 100 25 999.5

(51) Int. Cl. B41L 13/04

(52) U.S. Cl. 101/116

(57) ABSTRACT

A printing unit has two screen printing cylinders (12, 17) and a printing gap (14) formed by two cylinders (9, 16). At least the second cylinder of the two cylinders that form the printing gap is a transfer cylinder which co-operates with the second screen printing cylinder. A screen printing cylinder for the printing unit has a screen (23), a doctoring device which is situated radially inside said screen and a support element (36) which extends axially on the screen printing cylinder in the area of a limited peripheral section and which is used for sustaining a pressure exerted radially, outwards on the screen by the doctoring device when the limited peripheral section passes in front of said doctoring device.

The invention relates to a printing unit according to the preamble to claim 1.

EP 07 23 864 B1 has disclosed a printing unit for a rotary printing press, which has a first screen-printing cylinder and a printing nip formed by two cylinders, in which a print stock is printed.

A screen-printing cylinder of this printing unit forms a printing nip with a counter-pressure cylinder, which has circumference sections with a reduced radius in which sheet grippers are disposed. On the interior of the screen-printing cylinder, a doctor blade device is provided, oriented toward the printing nip; this doctor blade device presses against the screen of the screen-printing cylinder and pushes ink through it. In order to prevent the screen from being deformed when a circumference section with a reduced radius passes through the printing nip, a mechanism is provided which pulls the doctor blade device back from the screen at these times.

This known printing unit is only suitable for one-sided printing. The mechanism for retracting the doctor blade device is complex.

JP 11-129599 A has disclosed a screen-printing press with two screen-printing cylinders and a sheet-feeding transfer cylinder.

EP 0 949 069 A1 describes an offset printing press with cooperating transfer cylinders, which can be preceded by a screen-printing unit.

The object of the invention is to produce a printing unit.

The object is attained according to the invention by means of the characteristics of claim 1.

The advantages that can be achieved with the invention are comprised particularly in the fact that it permits first forme printing and second forme printing in the screen-printing process with matching registers to be executed in a single printing procedure. The screen-printing cylinder is distinguished in particular by its simple design.

In the printing unit according to the invention, at least one of the two screen-printing cylinders prints a first side of the print stock indirectly by means of a transfer cylinder; this transfer cylinder is the second of the two cylinders that form the printing nip and can therefore simultaneously serve as a counter-pressure cylinder for printing the second side of the print stock.

Preferably, the first of the two cylinders that form the printing nip is also a transfer cylinder, which results in an essentially symmetrical design of the printing unit with the same printing properties on both sides of the print stock.

In order to also permit an exact, register-matching printing in relation to the edge of a sheet-like print stock, preferably at least one of the two cylinders that form the printing nip is equipped with a holding mechanism for the sheet-like print stock.

In order to be able to apply ink to the screen-printing cylinders, they are each suitably provided with a doctor blade device on the interior, which is for pressing ink through a screen mounted on the screen cylinder. A device for preventing the doctor blade device from deforming the screen that it presses against is also advantageously provided in an established circumference section of the screen. This device prevents the screen from being excessively deformed when pressed against the holding mechanism or when pressed into a channel, which is complementary to the holding mechanism and is disposed on the respective other cylinder forming the printing nip, and thus prevents the screen from wearing too rapidly or being damaged.

A device of this kind can an adjusting mechanism, which retracts the doctor blade device radially inward when the established circumference section passes in front of the doctor blade device. According to a second aspect of the invention, the device is a support element, which extend axially on the screen-printing cylinder in the vicinity of the established circumference section and serves to absorb a pressure exerted by the doctor blade in a radially outward direction on the established circumference section.

In order to prevent synchronization errors of the screen-printing cylinder, when the doctor blade device comes into contact with the support element and/or leaves contact with it, the latter is preferably provided with leading and trailing edges for the doctor blade device, which extends at an angle to a generatrix of the circumference surface of the screen cylinder. Since the doctor blade device necessarily extends parallel to such generatrix, the doctor blade device does not come into contact or leave contact with the support element over its entire span, but only at certain points, and braking forces acting on the screen-printing cylinder therefore remain low and are distributed over a finite section of the circumference of the screen-printing cylinder.

Exemplary embodiments of the invention are shown in the drawings and will be described in detail below.

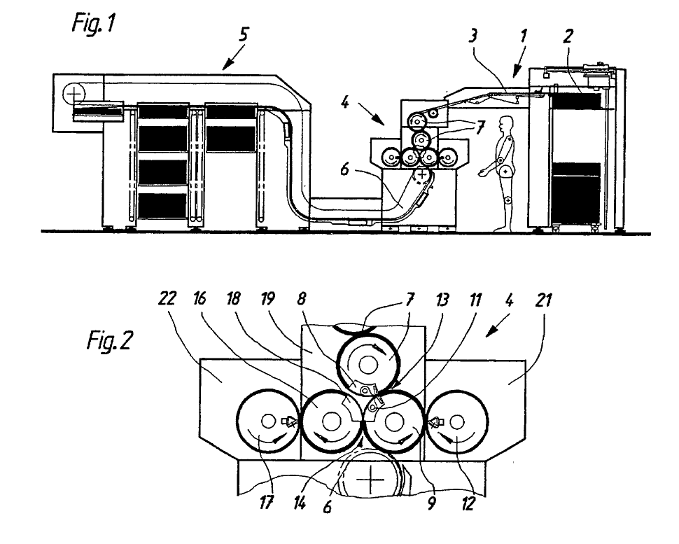

FIG. 1 is a schematic representation of a printing press with a printing unit;

FIG. 2 shows a schematic section through the printing unit of the machine from FIG. 1;

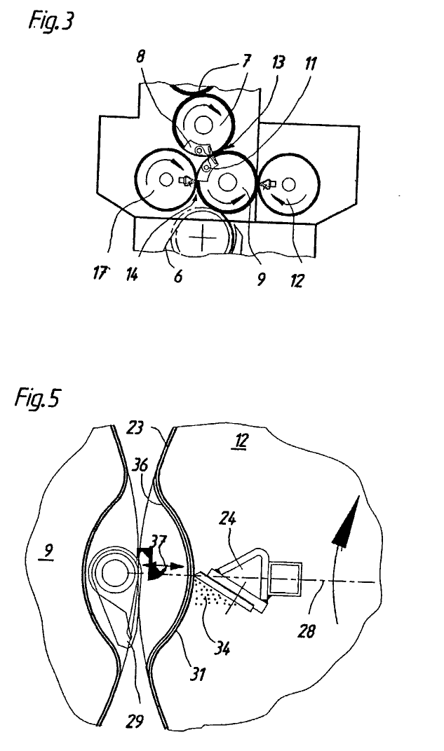

FIG. 3 shows a schematic section through a printing unit according to a second embodiment of the invention;

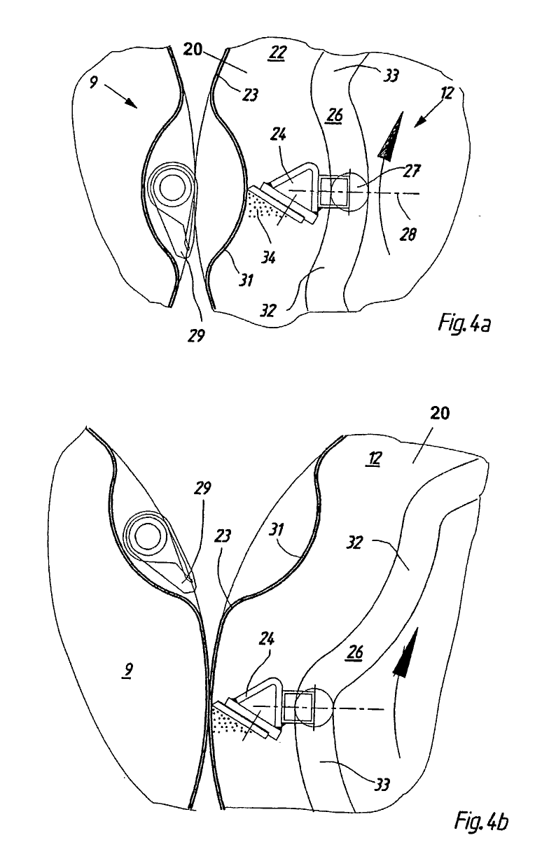

FIGS. 4a and 4b each show a detail of a screen-printing cylinder and a transfer cylinder cooperating with it, in two phases of the rotational movement of the cylinders;

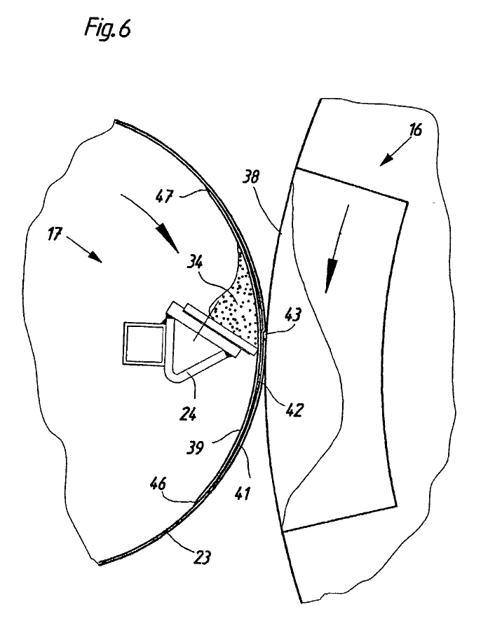

FIG. 5 shows a modification of the screen-printing cylinder from FIG. 4a;

FIG. 6 shows a detail of a screen-printing cylinder and a transfer cylinder according to a modified embodiment.

FIG. 1 shows a schematic view, e.g. of a sheet-fed rotary printing press in which the printing unit 4, for example, is used. The printing press has a sheet feeder 1 with a sheet stacker 2, from whose top, which is automatically kept at a constant height, sheets are fed individually or in a continuous stream by a belt conveyor 3 to the printing unit 4, which takes the sheets one at a time, prints them, and outputs them to a chain conveyor 6, which in the case of multicolor printing, feeds them to other printing units like the printing unit 4 or, as shown here, feeds them directly to an output stack 5.

The sheets pass through the printing unit 4 from top to bottom; FIG. 2 gives a larger scale depiction of its design.

Two transport cylinders 7, the upper of which is shown only partially in the figure, are each provided with sheet grippers in a respective section 8 of their circumferences in order to take the edges of sheets, which are to be printed, from the first belt conveyor 3 in a register-matching manner. The lower of the two transport cylinders 7 rolls in contact with a first transfer cylinder 9. The transfer cylinder 9 is embodied, for example, as a rubber blanket cylinder 9 and is likewise equipped with a gripper bridge in a section 11 of its circumference for taking the sheets from the lower transport cylinder 7. The first rubber blanket cylinder 9 also rolls in contact with a first screen-printing cylinder 12, by means of which a printing pattern is transferred to it, which is printed on a sheet conveyed in the nip 13 between the transport cylinder 7 and the first rubber blanket cylinder 9. The design of the first screen-printing cylinder 12 will be discussed in more detail below.

After passing through the nip 13, a sheet to be printed reaches a second nip 14 between the first rubber blanket cylinder 9 and a second transfer cylinder 16, which is also embodied as a rubber blanket cylinder 16. In this nip 14, the sheet is printed on its second side with a pattern that has been transferred to the second rubber blanket cylinder 16 from a second screen-printing cylinder 17.

The second rubber blanket cylinder 16 does not have a gripper bridge; instead, a section 18 of its circumference is provided with channel, which permits the gripper bridge 11 of the rubber blanket cylinder 9 to pass through the nip 14.

Since the two rubber blanket cylinders 9; 16 and with them, the screen-printing cylinders 12; 17 as well, can rotate in a coupled fashion, it is easy to achieve an exact and durable register matching of the printing on the front and back sides of the sheets by executing a manual or automatic fine adjustment of the printing formes mounted on the screen-printing cylinders 12; 17 in relation to each other in the axial direction and in the circumference direction of the cylinders 9; 16; 12; 17.

The various cylinders 7; 9; 16; 12; 17 mentioned above are each supported at the ends in lateral mounts 19; 21; 22. In the printing unit shown in FIG. 2, these lateral mounts 19; 21; 22 are comprised of a central module, which supports the transport cylinders 7 and the two rubber blanket cylinders 9; 16, as well as two lateral modules, which each support one of the screen-printing cylinders 12; 17. The end plates of a module are connected to each other so that they form a rigid frame unit, which can be removed from the printing unit 4 along with the screen-printing cylinder 12 or 17 that it supports. A module of this kind can be replaced, for example, by another module, which contains a forme cylinder, e.g. for conventional flat offset printing or the like. This permits the printing units to be easily adapted to a variety of requirements in order to print documents, in which different printing techniques are used for the front and back sides, with matching registers in a single pass.

FIG. 3 shows a simplified modification of the printing unit from FIG. 2. In this modification, elements that correspond to those of the printing unit from FIG. 2 are provided with the same reference numerals. The second rubber blanket cylinder 16 is omitted and instead, the second screen-printing cylinder 17′ forms the second printing nip 14 directly with the first rubber blanket cylinder 9. The first rubber blanket cylinder 9 consequently performs the function of a counter-pressure cylinder for the second screen-printing cylinder 17′.

Examples for the design of the screen-printing cylinder will be described below in conjunction with FIGS. 4a, 4b, and 5.

FIGS. 4a and 4b each show a partial region of the first screen-printing cylinder 12 in the vicinity of the nip, which it forms with the first rubber blanket cylinder 9. The structures described here, however, can also be used in the same way for the design of the second screen-printing cylinder 17.

The screen-printing cylinder 12 has a support ring 20 at each of its axial ends, whose outer circumference has a screen 23 stretched onto it, e.g. made of silk or polyamide gauze or bronze wire mesh. On the interior of the screen-printing cylinder 12, a doctor blade 24 is provided, whose position in the radial direction is controlled by a curved body, in this instance a guide slot 26 embodied at the ends of the screen-printing cylinder 12, through which a cylindrical guide projection 27 of the doctor blade 24 extends. Outside the screen-printing cylinder 12, the guide projection 27 is supported at both ends so that it can move in the direction of the line 28 connecting the rotation axes of the two cylinders 9; 12. FIG. 4a shows the doctor blade 24 in a position in which the holding mechanism 29 of the rubber blanket cylinder 9 is passing through the nip between the two cylinders 9; 12. Opposite from the holding mechanism 29, the screen 23 has a section 31 that is indented radially inward. The guide slot 26 has an arc-shaped section 33, not shown completely in the figure, which is concentric to the cylindrical outer surface of the screen 23, and an inwardly indented section 32, whose curvature corresponds to that of the section 31. The curvature of the section 32 is selected so that when the section 32 moves past the guide projection 27 during the rotation of the screen-printing cylinder 12, the doctor blade 24 is retracted radially inward so far that it exerts only a minimal pressure against the screen 23, which produces no appreciable deformation of the screen 23 in the section 31, or is retracted so far that it loses all contact with the screen 23 and consequently exerts no pressure on its section 31, which could deform this section and damage it during the course of operation.

FIG. 4b shows the position of the doctor blade 24 after the section 32 has passed the guide projection 27. The arc-shaped section 33 of the guide slot 26 keeps the doctor blade 24 pressed against the inside of the screen 23 so that an ink 34 disposed against the doctor blade 24 is pressed through the open regions of the screen 23 and is thus transferred to the rubber blanket cylinder 9.

FIG. 5 shows a modification of the screen-printing cylinder 12 from FIGS. 4a and 4b. Elements that correspond to those of the screen-printing cylinder 12 described above are provided with the same reference numerals and will not be described again. The design of the screen-printing cylinder 12 from FIG. 5 is simplified through the elimination of the guide slot 26. A spring device (not shown) keeps the doctor blade 24 pressed against the screen 23. The doctor blade 24 consequently remains in contact with the screen 23 even when the indented section 31 passes the doctor blade 24 during the course of the rotational motion of the screen-printing cylinder 12. When the indented section 31 passes in front of the doctor blade 24, the latter is pushed back counter to the force of the spring device toward the axis of the screen-printing cylinder 12. In order to prevent the doctor blade 24 from deforming the screen 23 in the section 31, the screen 23 is externally supported by a support element 36. The support element 36 here is the shape of a basin or trough that is uniformly curved in cross section, for example made of sheet metal or a rigid plastic, and is anchored at its two axial ends to the ends of the screen-printing cylinder 12. Advantageously, the leading and trailing ends of the screen 23 are also disposed in the section 31 covered by the support element 36. The support element 36 can be adjusted in the radial direction (arrow 37) in order to set the tension of the screen 23.

During the rotation of the cylinders 9; 12 of the printing unit, since the support element 36 respectively coincides with the holding mechanism 29 of the rubber blanket cylinder 9 and consequently no ink can be accepted from the screen-printing cylinder 12 in the vicinity of the section 31, it is useful for the support element 36 to be embodied as a closed plate, which does not permit any ink to pass through and reach the exterior of the screen-printing cylinder 12.

FIG. 6 shows a detail of an alternative design of a screen-printing cylinder 17.

This screen-printing cylinder 17 is cylindrical over its entire circumference, without an indented section. It is therefore suitable for cooperating with a second cylinder, which has no radially outward-protruding elements such as holding mechanisms for a print stock. With reference to the printing unit from FIG. 1, the second screen-printing cylinder 17 can have the design shown in FIG. 6. Hence in the description that follows, the screen-printing cylinder is labeled 17 and the cylinder that cooperates with it is labeled 16.

As in the case of the screen-printing cylinder from FIGS. 4a, 4b, and 5, a doctor blade 24 is disposed on the inside of the screen-printing cylinder 17 shown here, and pushes a paste-like ink 34 through the screen 23 stretched on the screen-printing cylinder 17 and thereby exerts a radially outward pressure on the screen 23. In the joint rotation of the screen-printing cylinder 17 and the rubber blanket cylinder 16, as long as the screen 23 touches the surface of the rubber blanket cylinder 16, this cylinder supplies a counter-pressure, which prevents the doctor blade 24 from deforming the screen 23. In order to prevent such a deformation even in the vicinity of the channel 38 in which the screen 23 is not in contact with the rubber blanket cylinder 16, a support element 39 is disposed radially inside the screen 23 and extends in the circumference direction of the screen-printing cylinder 17 over a section 41 of the screen 23, which corresponds to the span of the channel 38 on the rubber blanket cylinder 16. The support element 39 is embodied as a closed plate made of metal or rigid plastic, which is curved in the form of a cylinder segment.

In this instance, the support element 39 is attached radially inside the screen 23 and the leading end 42 and trailing end 43 of the screen 23 overlap each other in the section 41 supported by the support element 39. Thus, the sensitive connection between the two ends 42; 43, which can be welded for example, is protected from contact with the doctor blade 24 and is therefore protected from premature wear.

A spring element for moving the doctor blade 24 in the radial direction could also be provided in this embodiment of a screen-printing cylinder 17. However, since in this embodiment, the inner radius of the surface that the doctor blade 24 sweeps across, the design of the screen-printing cylinder 17 can be further simplified by eliminating the adjustability of the doctor blade 24 so that the fluctuations in the radius are compensated for solely through an elastic deformation of the elastic lip 44 of the doctor blade 24 touching the screen 23.

In a design of this kind, in order to facilitate the transition of the doctor blade 24 from the screen 23, onto the support element 39, and back onto the screen 23 again, and in order to avoid synchronization errors of the screen-printing cylinder 17, the support element 39 is provided with a leading edge 46 and a trailing edge 47, which are beveled in the circumference direction of the screen-printing cylinder 17. In addition, the invention provides that these edges 46; 47 do not extend exactly parallel to a generatrix of the outer surface of the screen-printing cylinder 17 or to the lip 16 of the doctor blade 24, but extend at a slight angle to them. For example, a sawtoothed, rafter-shaped, or sinusoidal curve of the edges 46; 47 is conceivable; preferably the edges 46; 47 each represent a helix with a pitch that is a multiple of the axial length of the screen-printing cylinder 17. When the doctor blade 24 is running onto them or off of them, such a curvature of the edges 46; 47 prevents braking or acceleration forces acting on the screen-printing cylinder 17 from being exerted only at a certain point in time and at a particular angular position of the screen-printing cylinder 17; instead, these forces are distributed over a circumference section of the screen-printing cylinder 17 which, depending on the dimensions of the screen-printing cylinder 17, can be from several millimeters up to a few centimeters wide. This smoothes the torque required to drive the screen-printing cylinder 17 and prevents synchronization errors.

Reference Numeral List

| | |
|---|---|
| 1 | sheet feeder |
| 2 | sheet stack |
| 3 | belt conveyor |
| 4 | printing unit |
| 5 | output stack |
| 6 | chain conveyor |
| 7 | transport cylinder |
| 8 | section |
| 9 | transfer cylinder, rubber blanket cylinder |
| 10 | — |
| 11 | section |
| 12 | screen-printing cylinder |
| 13 | nip |
| 14 | nip |
| 15 | — |
| 16 | transfer cylinder, rubber blanket cylinder |
| 17 | screen-printing cylinder |
| 17′ | screen-printing cylinder |
| 18 | section |
| 19 | lateral mount |
| 20 | support ring |
| 21 | lateral mount |
| 22 | lateral mount |
| 23 | screen |
| 24 | doctor blade |
| 25 | — |
| 26 | guide slot |
| 27 | guide projection |
| 28 | line |
| 29 | holding mechanism |
| 30 | — |
| 31 | section (23) |
| 32 | section (26) |
| 33 | section (26) |
| 34 | ink |
| 35 | — |
| 36 | support element |
| 37 | arrow |
| 38 | channel |
| 39 | support element |
| 40 | — |
| 41 | section (23) |
| 42 | leading end |
| 43 | trailing end |
| 44 | lip |
| 45 | — |
| 46 | leading edge |
| 47 | trailing edge |

1. A printing unit with a first screen-printing cylinder (12) and a second screen-printing cylinder (17), in which a first transfer cylinder (9) is provided, which cooperates with the first screen-printing cylinder (12), characterized in that a second transfer cylinder (16) is provided, which cooperates with the second screen-printing cylinder (17) and that the first transfer cylinder (9) and second transfer cylinder (16) form a printing nip (14).

2. The printing unit according to claim 1, characterized in that one of the transfer cylinders (9) has a holding mechanism (29) for sheet-like print stocks.

3. The printing unit according to claim 1, characterized in that the screen-printing cylinders (17, 12) have a device (26, 36, 39) for preventing a deformation of their screen (23) at an established section (31; 41) of the screen (23).

4. The printing unit according to claim 3, characterized in that the device for preventing a deformation includes a guide slot (26), which retracts a doctor blade (24) radially inward when the established section (31) passes in front of the doctor blade (24).

5. The printing unit according to claim 1, characterized in that the printing unit is modularly designed and the screen-printing cylinders (12; 17) each constitute a removable module (21; 22).
